(19) United States
(12) Patent Application Publication
(10) Pub. No.: US 2006/0244275 A1
(43) Pub. Date: Nov. 2, 2006

(54) Barbecue utensil

(76) Inventor: Edward H. Bases, New York, NY (US)

Correspondence Address: GOTTLIEB RACKMAN & REISMAN PC, 270 MADISON AVENUE, 8TH FLOOR, NEW YORK, NY, 100160601, US

(21) Appl. No.: 11/120,029

(22) Filed: May 2, 2005

(51) Int. Cl. A47J 43/28

(52) U.S. Cl. 294/3

(57) ABSTRACT

A y-shaped cooking utensil includes two colinear members, one member having two arms defining a tong. The ends of each arm and the end of the other member terminate with cooking tools, including a spatula, a sharp cutting edge, a fork and a spoon. The two members can be folded toward each other for storage.

### BACKGROUND OF THE INVENTION

a. Field of Invention

This invention pertains to barbecue and cooking utensils and more particularly to a utensil that with a tong at one end and a cooking tool at the other.

b. Description of the Prior Art

Multipurpose utensils are well known in the art, as described in U.S. Pat. Nos. 3,596,965; 4,823,419; 5,774,990; 6.682,112; 5,934,721 and D411,080. These types of utensils are particularly useful for outdoor barbecues because a person does not have to carry a different utensil for each purpose. However, the existing utensils are not very practical and accordingly very few of them have been accepted by the market.

### SUMMARY OF THE INVENTION

Briefly, a cooking tool constructed in accordance with this invention is generally Y-shaped and includes two members that, in use, are collinear. One member is formed with two arms joined by an intermediate zone that allows the arms to bend with respect to each and define a tong. The second member and the two arms, each terminate with a cooking tool. For example, the second member terminates with a flat spatula. One edge of the spatula is sharpened to make a cutting tool. Similarly, one of the arms is terminated with a fork while the other arm is terminated with a spoon.

Advantageously, a hinge is provided that allows one of the members to swivel or rotate with respect to each other until the two members are adjacent. In this configuration, the two barbecue tool can be stored easily.

### BRIEF DESCRIPTION OF THE DRAWINGS

FIG. 1 shows a side view of a utensil constructed in accordance with this invention; and

FIG. 2 shows a bottom view of the utensil of FIG. 1.

### DETAILED DESCRIPTION OF THE INVENTION

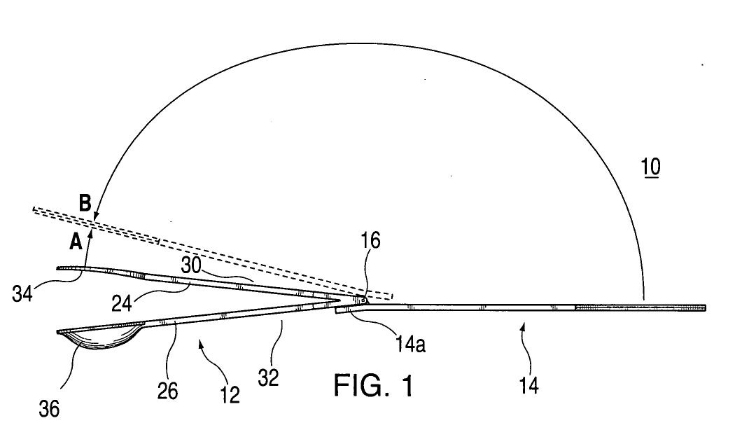

Referring now to the Figures, a utensil 10 constructed in accordance with this invention is composed of two segments or members which, in use, extend collinearly along a common longitudinal axis. The first segment is a tong 12 and the second segment is a spatula 14. The two segments are connected by a hinging mechanism 16. This hinging mechanism allows the two segments to swing or swivel toward each other around either a vertical or a horizontal axis defined by the hinging mechanism 16, as indicated by arrows A and B until they are in close proximity to each other. In this closed configuration, (indicated in FIG. 1 by the dotted lines) the utensil 10 is easy to store and to ship.

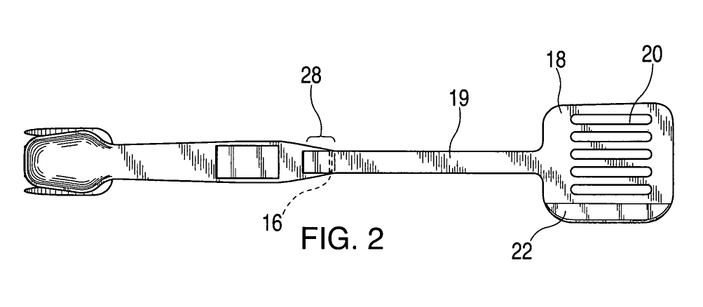

The spatula 14 has an extension 14A disposed beyond the hinging mechanism 16 and is provided to act as a stop and stabilize the spatula. Details of the spatula can be seen in FIG. 2. It includes a rod 19 terminating with a flat area 18 formed with slots 20. At least one edge 22 of the flat area 18 is flat and sharp so that it can be used as a knife.

Tong 12 includes two arms 24, 26. These two arms are joined at a common zone 28. This zone is flexible to allow the arms to bend toward each other. The ends of the arms 24, 26 can then be used to grasp things, such as food stuff on a barbecue. Alternatively, the common zone consists of a second hinging mechanism that includes a spring (not shown) biasing the two arms away from each other.

Preferably the arms 24, 26 have ergonomically shaped handles 30, 32 constructed and arranged to allow the arms to be squeezed together.

The ends of the arms can be identical. However, in a preferred embodiment shown in the Figures, one arm 24 ends with a plurality of parallel tines 34 to form a fork. The end of the second arm 26 is terminated with a flat portion with a depression defining a spoon 36.

The utensil 10 can be made of a plastic material or any other that is resistant to high temperatures or a metallic material or alloy. In this latter case, the handles 30, 32 are made of a heat insulating material, such as wood or plastic, to insure that a user does not burn himself.

Thus, a barbecue utensil 10 is presented that includes two segments or members with tools. The utensil is very useful for barbecuing, and has a spatula, a cutting knife (, a tong, a fork and a spoon. The two members 12, 14 in the open position are long to allow the utensil to be used over a fire, or a hot surface without exposure to heat. Once the cooking is finished, the utensil 10 can be cleaned, and then folded in two to reduce its overall length, and then stored.

Obviously numerous modifications may be made to the invention without departing from its scope as defined in the appended claims.

1. A barbecue utensil comprising:
a first member and a second member, said first member including two arms joined by a flexing element to form a tong, and said second member terminating in a tool useful for cooking said second member being collinear with one of said arms to form a Y-shaped body.

2. The barbecue utensil of claim 1 wherein said second member is terminated with a flat area defining a spatula.

3. The barbecue utensil of claim 2 wherein said flat area has a sharp edge for cutting.

4. The barbecue utensil of claim 1 wherein said flexing zone is formed by a flexible intermediate zone.

5. The barbecue utensil of claim 4 wherein said two arms are joined by a second hinging means.

6. The barbecue utensil of claim 4 wherein one of said arms is terminated with a fork.

7. The barbecue utensil of claim 4 wherein the other arm is terminated with a spoon.

8. (canceled)

9. A barbecue utensil comprising:
a body with one member attached to a second member, said one member including two arms joined by a flexible zone to allow said arms to bend toward each other and define a tong, and said second member terminating in a first cooking tool wherein said second member forms a handle for using said tong, wherein said first member forms another handle for using said barbecue utensil; and
a hinge pivoting said one member with respect to said second member between a first configuration in which said second member is collinear with one of said arms and said body has Y-shape and a second configuration in which said second member is disposed adjacent to one of said arms and said body has a V-shape.

10. The barbecue utensil of claim 9 wherein said the arms of said first member and said second member terminate with a second and a third cooking tool, respectively.

11. The barbecue utensil of claim 10 wherein said cooking tools include a spatula, a cutting edge, a fork and a spoon.

12. The barbecue utensil of claim 11 wherein said second member terminates with said spatula.

13. The barbecue utensil of claim 12 wherein said spatula terminates with a sharp edge.

14. The barbecue utensil of claim 11 wherein said arms terminate with a fork and a spoon, respectively.

15. The barbecue utensil of claim 11 wherein said arms are provided with respective handle means.

16. (canceled)

17. (canceled)

18. The utensil of claim 9 wherein said second configuration has a length equal to the length of one of the members.

19. The utensil of claim 1 wherein said two arms and said second member have generally flat surfaces and said hinge pivots said members along an axis parallel to said flat surfaces.
